(19) United States
(12) Patent Application Publication
(10) Pub. No.: US 2017/0333285 A1
(43) Pub. Date: Nov. 23, 2017

(54) MEDICATION VIAL COVERS

(71) Applicant: Jodi Lecuyer, Harrow (CA)

(72) Inventor: Jodi Lecuyer, Harrow (CA)

(21) Appl. No.: 15/592,297

(22) Filed: May 11, 2017

Related U.S. Application Data
(60) Provisional application No. 62/338,805, filed on May 19, 2016.

(51) Int. Cl. A61J 1/18; A61J 1/14

(52) U.S. Cl. CPC A61J 1/18; A61J 1/1412; A61J 2205/40; A61J 2205/20

(57) ABSTRACT

Covers for vial containers are described. The cover can include at least one side and an end. The at least one side and the end can form a cavity configured to receive a portion of a vial. The cover further includes an identifier located on the end of the cover. The identifier can include a shape associated with a particular medication. Such arrangements can assist visually impaired users in quickly and easily identifying the types of medication in a particular vial.

### CROSS REFERENCE TO RELATED APPLICATIONS

This application claims benefit of U.S. Provisional Application No. 62/338,805 filed on May 19, 2016, which is herein incorporated by reference in its entirety.

### FIELD

The subject matter described herein relates in general to container covers and, more particularly, to medication vial covers for the visually impaired.

### BACKGROUND

There are many different kinds of vials designed for retaining small items. For example, medication can be issued, sold, and/or stored in medication vials. Often times identifying information and/or instructions can be provided on the vial in text format. The visually impaired, such as elderly patients, may have a difficult time identifying particular vials.

### SUMMARY

In one example, the present disclosure is directed to a cover for vial containers. The cover includes at least one side and an end. The at least one side and the end form a cavity configured to receive a portion of a vial. The cover further includes an identifier located on the end of the cover. The identifier includes a shape associated with a particular medication.

In another example, the present disclosure is directed to a vial system for holding medication. The system includes a vial having an open top and a closed bottom end. The system further includes a vial cover configured for operative connection to the vial. The cover includes at least one side and an end. The at least one side and the end form a cavity configured to receive a portion of the vial. The cover further includes an identifier located on the end of the cover. The identifier includes a shape associated with a medication held in the vial.

In yet another example, the present disclosure is directed to a cover kit for use with vial containers. The kit includes a first cover including at least one side and an end. The at least one side and the end form a cavity configured to receive a portion of a first vial. The first cover further includes a first identifier located on the end of the cover. The first identifier includes a first shape associated with a first medication. The kit further includes a second cover including at least one side and an end. The at least one side and the end form a cavity configured to receive a portion of a second vial. The second cover further includes a second identifier located on the end of the cover. The second identifier includes a second shape associated with a second medication.

### BRIEF DESCRIPTION OF THE DRAWINGS

FIGS. 1A-1C show an example of a medication vial cover.

FIG. 2 shows example identifier shapes, colors, and uses for vial cap covers.

FIGS. 3A-3D show an example of medication vial cover having a first example identifier.

FIGS. 4A-4D show an example of medication vial cover having a second example identifier.

FIGS. 5A-5D show an example of medication vial cover having a third example identifier.

FIGS. 6A-6D show an example of medication vial cover having a fourth example identifier.

FIGS. 7A-7D show an example of medication vial cover having a fifth example identifier.

FIGS. 8A-8D show an example of medication vial cover having a sixth example identifier.

FIGS. 9A-9C show another example of a medication vial cover that covers a vial cap.

### DETAILED DESCRIPTION

Arrangements described herein relate to covers for vial containers. In some arrangements, a vial can contain medication. The cover can be operatively connected to, and cover, a portion of a vial such as a bottom end or a vial cap. The cover can include an identifier and/or colors to convey to a user an associated item contained in the vial. For example, the identifier and/or color can convey a type of medication contained within the vial. Arrangements described herein can assist visually impaired users in quickly and easily identifying the types of medication in a particular vial.

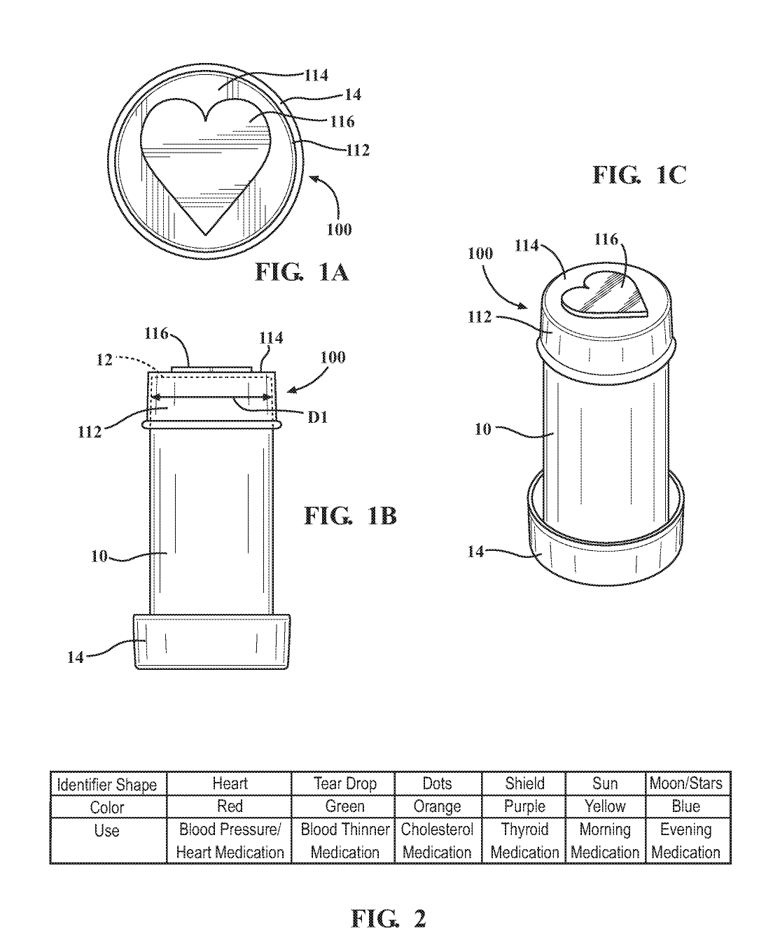

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9C, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIGS. 1A-1C, an example of a cover 100 is shown. The cover 100 is shown in an attached position to a vial 10. As used herein, “vial” means any container configured to retain small items. In one or more implementations, the vial 10 can be a medication container. For example, the vial 10 can be configured to retain prescription or non-prescription medication in any suitable form. In one or more arrangements, the vial 10 can be substantially cylindrical in shape, with a closed bottom end 12 and an open top end (not shown). As used herein, the term “substantially” includes exactly the term it modifies and slight variations therefrom. Thus, the term “substantially cylindrical” or “cylindrical” means exactly cylindrical and slight variations therefrom. The vial 10 can include a vial cap 14 configured to selectively cover the open top end. While arrangements will be described with respect to medicine containers, it will be understood that embodiments are not limited to such containers.

Some of the possible elements of the cover 100 are shown in FIGS. 1A-1C and will now be described. It will be understood that it is not necessary for the cover 100 to have all of the elements shown in the Figures or described herein. The cover 100 can have any combination of the various elements shown throughout the Figures. Further, the cover 100 can have additional elements to those shown in the Figures. In some arrangements, the cover 100 may not include one or more of the elements shown in the Figures.

The cover 100 can be configured to operatively connect to, and cover, at least a portion of the vial 10. The term “operatively connected,” as used herein, can include direct or indirect connections, including connections without direct physical contact. In the way of the examples, the cover 100 can be configured for operative connection to the vial 10 by one or more fasteners, mechanical engagement, threaded engagement, adhesives, friction, suction, and/or combinations thereof.

The cover 100 can include one or more sides 112 and an end 114. In one or more arrangements, the side(s) 112 and the end 114 can form a cavity to receive a portion of the vial 10. For instance, in one example, the side 112 can be a curved shape configured to extend around a portion of the vial 10. The side 112 can be substantially cylindrical in shape. Such an arrangement can also include a side 112 that is slightly angled such that the side 112 forms a conical frustum shape. That is, the diameter of the side 112 can change along a longitudinal direction. In one or more arrangements, the end 114 can include one or more substantially planar surface portions. The side 112 and the end 114 can, in some arrangements, form substantially a cylinder, with one end closed (by the end 114).

In one or more arrangements, the cover 100 can be configured to operatively connect to the vial 10 by being placed over, and receiving, a portion of the vial 10. In one or more arrangements, the cover 100 can be configured to operatively connect to the vial 10 by being placed over, and receiving, a portion of the bottom end 12 of the vial 10. As used herein, “bottom end” means an end of the vial opposite to an open end, and is not meant to be limiting. As described in further detail below, the vial 10 may be positioned such that the bottom end 12 is located above the open end. An example of a cover 100 configured to operatively connected to the bottom end 12 is shown in FIGS. 1A-1C. For example, the side 112 can be shaped to substantially match the shape and/or contour of a side surface of the vial 10 near the bottom end 12. In one or more arrangements, the cover 100 can be operatively connected to the bottom end 12 of the vial 10 via a frictional or interference fit between the side 112 and the vial 10. For example, the cover 100 can include elastomeric and/or pliable material to allow the side 112 to be stretched over the bottom end 12 of the vial 10. In some arrangements, the side 112 can remain in direct physical contact with the vial when the cover 100 is in an attached position. As such, the cover 100 can be removable and reusable with multiple vials, non-destructive to the vial 10 or the cover 100.

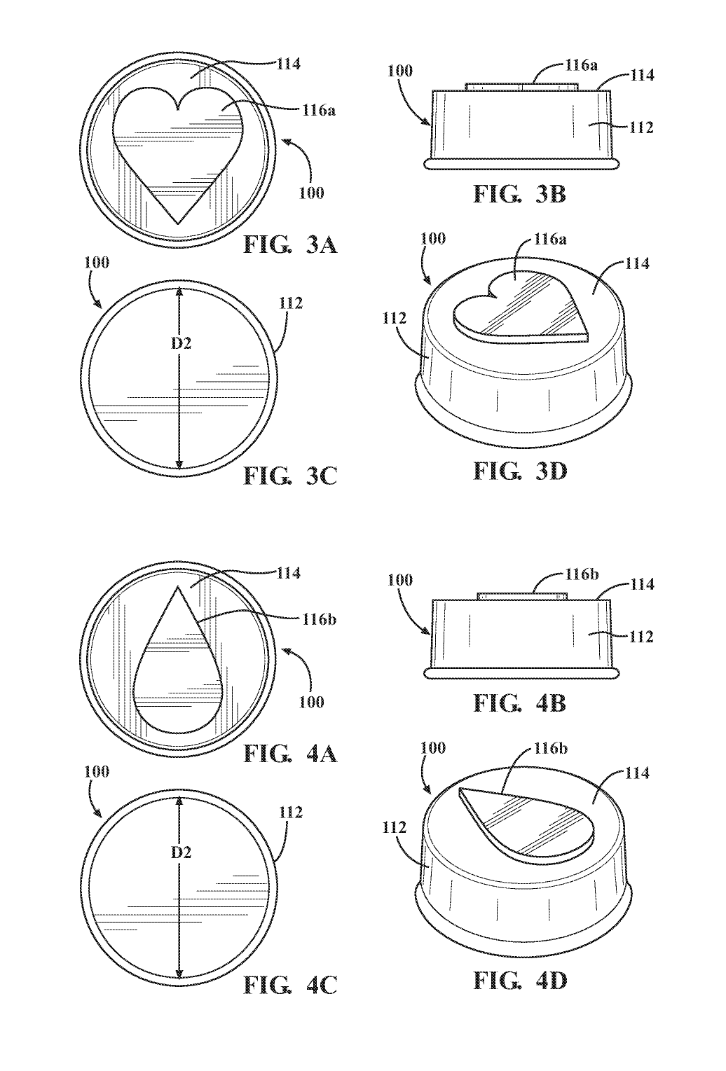

In one or more arrangements, the vial 10 can have an outer diameter D1 near the bottom end 12. In some arrangements, an inside diameter of the cover 100 can be substantially equal to the outer diameter D1 when the cover 100 is operatively connected to the vial 10. For instance, the inner diameter D2 of the cover 100, as shown in FIGS. 3A-8D, can be substantially equal to the outer diameter D1 of the vial 10. Alternatively, the inner diameter D2 of the cover 100 can be smaller than the outer diameter D1 of the vial 10, and the cover 100 can be stretched to increase the inner diameter D2 when operatively connected to the vial 10.

In one or more arrangements, the vial 10 can be a medication vial having standard dimensions. That is, the vial 10 can be a medication vial having dimensions that are common throughout the medical industry. In some arrangements, common outer diameters D1 of the vial 10 can include 1.05 inches, and/or 1.5 inches. The cover 100 can be configured to operatively connect to vials 10 having one of these standard dimensions.

In some arrangements in which the cover 100 is operatively connected to the bottom end 12 of the vial 10, the vial 10 may be stored “upside-down,” resting on the vial cap 14. This can allow the cover 100 to be visible when the vial 10 is stored. In some arrangements, the cover 100 can be useable on multiple vials 10 having similarly sized bottom ends 12, regardless of vial cap 14 characteristics. For instance, the cover 100 can be used on a first vial having a first sized vial cap and also on a second vial having a second sized vial cap, provided that both the first and second vials have a bottom end 12 with similar characteristics.

In one or more arrangements, the cover 100 can include one or more identifiers 116. For instance, the identifier(s) 116 can be located at the end 114 of the cover 100. Alternatively or in addition, one or more identifier(s) 116 can be located at other positions of the cover 100. The identifiers 116 can be configured to convey to a user what type of contents the cover 100 is associated with. As described below, the identifier(s) 116 can include certain shapes and/or colors to be easily identifiable by a user.

In one or more arrangements, the identifier(s) 116 can be embossed and/or debossed in the end 114. As used herein, “emboss” includes any forming, carving, molding, etching, and/or stamping into a surface such that a feature stands out in relief and/or is otherwise raised from a surface. “Deboss” can include any forming, stamping, carving, etching, and/or molding such that a feature is indented in a surface. Alternatively or in addition, the identifier(s) 116 can be incorporated with the end 114 in any suitable manner. For example, the identifier(s) 116 can be marked with an ink and/or dye, laser etched, and/or a separate material attached to the end 114.

The identifier(s) 116 can stand out in relief or be indented by any suitable distance. Further, the identifier(s) 116 can have any suitable texture. For example, the identifier(s) 116 can have a different texture than the rest of the end 114. In some arrangements, a rougher texture of the identifier(s) 116 can assist a user in identifying what medicine the cover 100 is associated with. In some examples, the identifier(s) 116 can include braille, letters, numbers, characters and/or any other markings designed to be felt by a user.

In one or more arrangements, the cover 100 can include portions of a certain color to convey an associated medicine. For example, the cover 100 can be colored as described in FIG. 2 as described below. In one or more arrangements, the entire cover 100 can be a certain color. Alternatively, portions of the cover 100 can be different colors. For example, the identifier 116 can be colored differently than surrounding surfaces of the cover 100.

In one or more arrangements, the cover 100 can be associated with particular contents. For instance, the cover 100 can be associated with a type of medication to convey to a user which medication is contained within the vial 10 of which the cover 100 is covering. FIG. 2 shows a chart having non-limiting characteristics of the cover 100 as well as a use for associated medicine. For example, a shape of the identifier 116 and/or a color of a portion of the cover 100 can be used to convey a type/use of medication. Some non-limiting examples for types of medications uses that can have unique covers 100 can include blood pressure/heart medication, blood thinner medication, cholesterol medication, thyroid medication, morning (AM) medication, and/or afternoon/evening (PM) medication.

In one or more arrangements, a cover 100 having a heart shaped identifier that is colored red can be used for blood pressure or heart medication. In one or more arrangements, a cover 100 having a tear drop shaped identifier that is colored green can be used for blood thinner medication. In one or more arrangements, a cover 100 having dot shapes as an identifier that is colored orange can be used for cholesterol medication. In one or more arrangements, a cover 100 having a shield shaped identifier that is colored purple can be used for thyroid medication. In one or more arrangements, a cover 100 having a sun shaped identifier that is colored yellow can be used for morning or daytime medication. In one or more arrangements, a cover 100 having a moon or star shaped identifier that is colored blue can be used for afternoon or evening medication.

FIGS. 3A-8D show non-limiting examples of covers 100 having different identifiers 116. FIGS. 3A-3D show a top, side, bottom, and isometric view of a cover 100 having a first identifier 116a having a heart shape. In one or more arrangements, the cover 100 of FIGS. 3A-3D can be associated with blood pressure or heart medication.

FIGS. 4A-4D show a top, side, bottom, and isometric view of a cover 100 having a second identifier 116b having a tear drop shape. In one or more arrangements, the cover 100 of FIGS. 4A-4D can be associated with blood thinner medication.

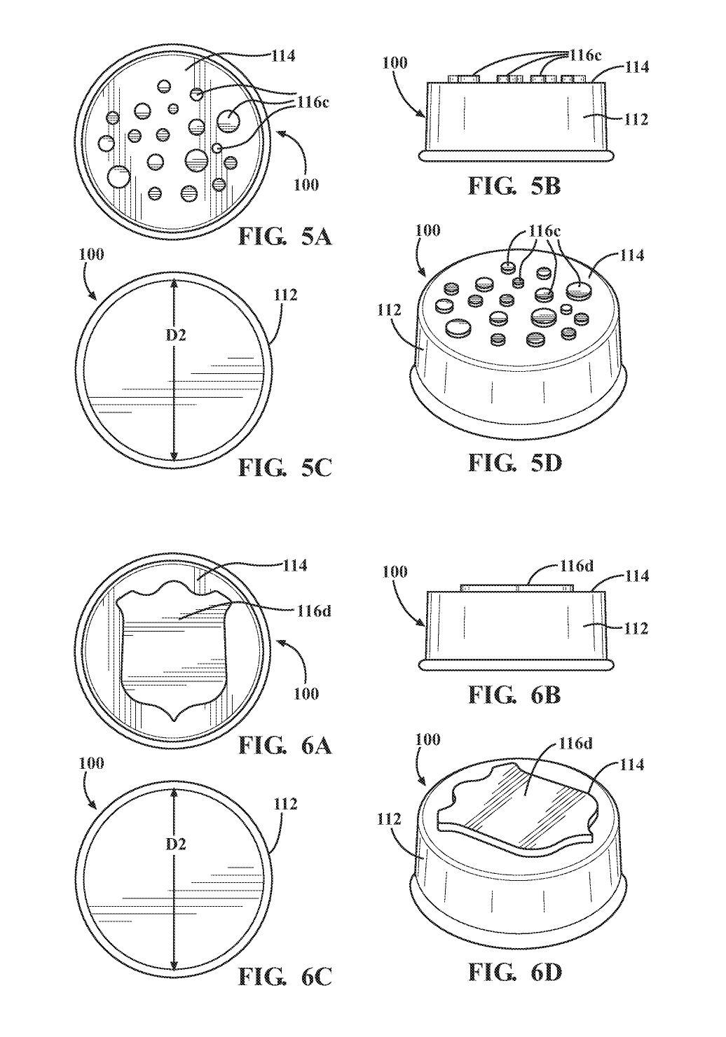

FIGS. 5A-5D show a top, side, bottom, and isometric view of a cover 100 having a third identifier 116c shaped as several dots. In one or more arrangements, the cover 100 of FIGS. 5A-5D can be associated with cholesterol medication.

FIGS. 6A-6D show a top, side, bottom, and isometric view of a cover 100 having a fourth identifier 116d having a shield shape. In one or more arrangements, the cover 100 of FIGS. 6A-6D can be associated with thyroid medication.

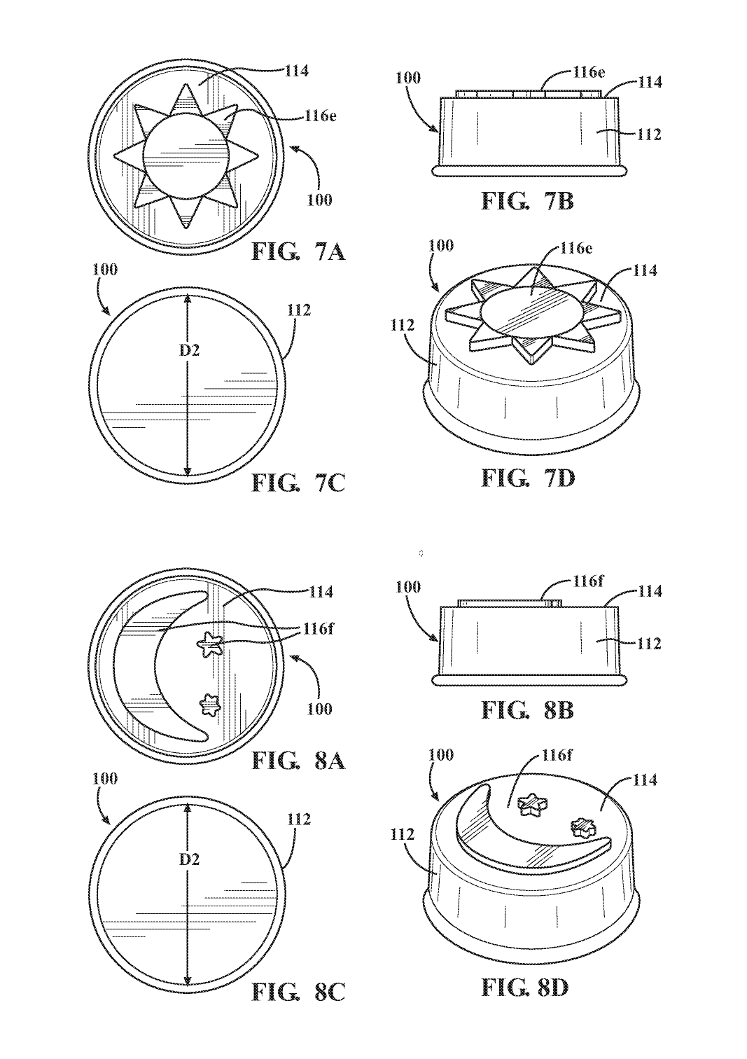

FIGS. 7A-7D show a top, side, bottom, and isometric view of a cover 100 having a fifth identifier 116e having a sun shape. In one or more arrangements, the cover 100 of FIGS. 7A-7D can be associated with morning medication.

FIGS. 8A-8D show a top, side, bottom, and isometric view of a cover 100 having a sixth identifier 116f having moon and/or stars shapes. In one or more arrangements, the cover 100 of FIGS. 7A-7D can be associated with afternoon or evening medication.

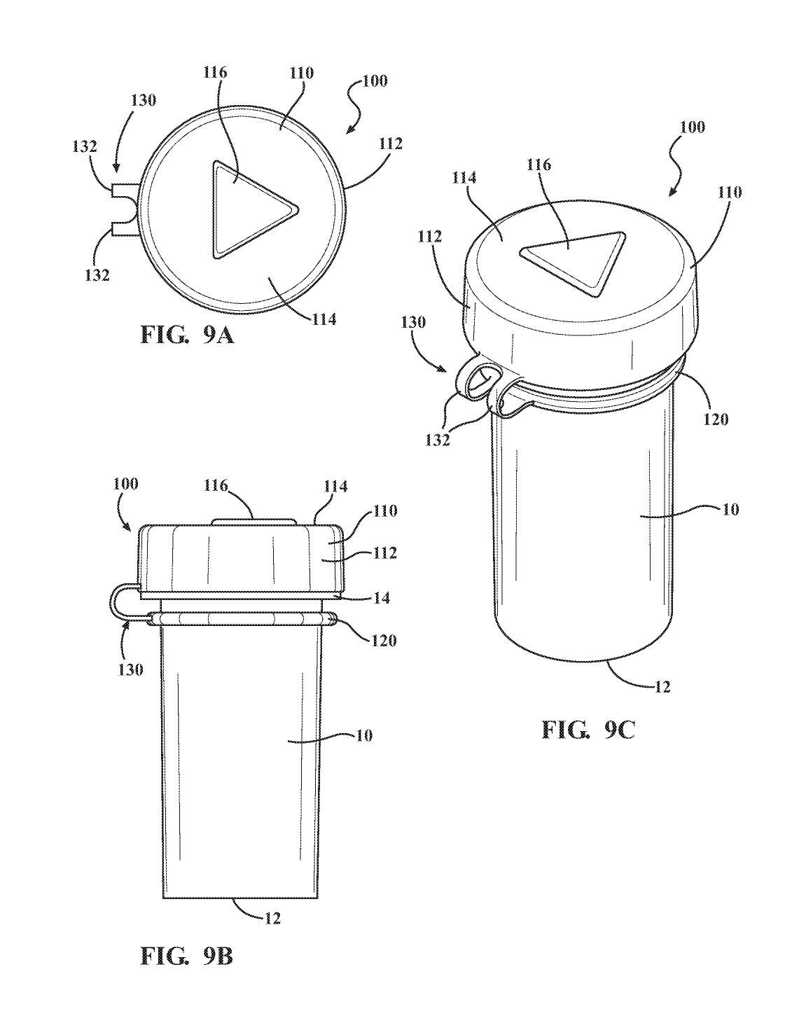

Referring to FIGS. 9A-9C, another example of the cover 100 can be shown and described. In one or more arrangements, the cover 100 can be configured to cover at least a portion of the vial cap 14. For example, the cover 100 can include a top portion 110 configured to cover a portion of the vial cap 14. In some arrangements, the cover 100 can also include a retaining portion 120 to retain the cover 100 to the vial 10 when the vial cap 14 and/or top portion 110 are moved. The retaining portion 120 can be connected to the top portion 110 via a hinge 130. In one or more arrangements, the retaining portion 120 can be configured to be operatively connected to a body of the vial 10. In some examples, the retaining portion 120 can be ring-shaped and configured to extend around a circumference or outer perimeter of the vial 10. Alternatively, the retaining portion 120 can be shaped as a partial ring and be configured to extend partially around an outer perimeter of the vial 10. Alternatively or in addition, the retaining portion 120 can be configured for operative connection to the vial 10 by one or more fasteners, mechanical engagement, threaded engagement, adhesives, and/or combinations thereof.

The cover 100 can include a hinge portion 130 that connects the top portion 110 and the retaining portion 120. In one or more arrangements, the hinge portion 130 can include one or more connectors 132 that extend between the top portion 110 and the retaining portion 120. For example, the hinge portion 130 can include two connectors 132 as shown in FIGS. 9A and 9C. The connectors 132 can be configured to be hingeable and/or pliable to allow relative movement and/or rotation of the top portion 110 relative to the retaining portion 120. For example, in FIGS. 9A-9C, the connectors 132 can be configured to allow the vial cap 14 along with the top portion 110 to move relative to the vial 10 and the retaining portion 120.

In one or more arrangements, the top portion 110, the retaining portion 120, and the hinge portion 130 can be formed as a single unitary structure. Alternatively, one or more of the top portion 110, the retaining portion 120, and/or the hinge portion 130 can be formed separately and subsequently operatively connected.

The cover 100 can be made of any suitable material. For instance, the cover 100 can be made of plastic, resin, silicone, rubber, and/or any composite material. The cover 100 can be made of a single material. Alternatively, the cover 100 can be made of a plurality of materials. The material may be hard or soft. The material can have a substantially constant density or the density can vary in one or more places within the cover 100. In a non-limiting example, the material of the cover 100 can include a polyethylene (PE), a thermoplastic rubber (TPR) and/or a thermoplastic urethane (TPU).

The cover 100 can have any suitable size, shape, and/or configuration. For instance, the cover 100 can be sized to receive and cover at least a portion of a vial cap 14. The cover 100 can have any suitable thickness. The thickness (e.g., the thickness of the side 112 and/or the end 114) can be a constant thickness. Alternatively, the thickness of the cover 100 can vary at one or more locations. In one non-limiting example, the thickness of the cap cover, such as the side 112, can be about 0.75 millimeters (mm) to about 1.00 mm. At least a portion of the cover 100, such as the side 112 and/or identifier 116, can have varying grips, textures, etc. The cover 100 can be formed by any suitable process, now known or developed in the future. For example, the cover 100 can be formed using injection molding processes, forming either one unitary structure or separate structures.

In one or more arrangements, a plurality of covers 100 can be packaged, sold, grouped, and or otherwise provided as a kit. In some instances, the plurality of covers 100 in a kit can differ from each other in one or more respects. For example, one or more of the plurality of covers 100 in a kit can include a different identifier 116, different color, different size, different material, and/or different texture than other covers 100 within the kit. In some arrangements, a kit can include covers 100 having different identifiers 116 for different medication uses. For example, a kit can include any combination of covers 100 having blood pressure, thyroid, diabetes, blood thinner, morning (AM), afternoon/evening (PM), and/or cholesterol medications identifiers 116. In a non-limiting example, a kit can include three covers 100, including a cover for a blood pressure medication, a cover for a morning medication, and a cover for an evening medication. Alternatively or in addition, a kit can include two or more covers having substantially the same attributes. In one or more arrangements, one or more covers 100 can be packaged, sold, grouped, or otherwise provided as a kit with one or more vials 10.

It will be appreciated that arrangements described herein can provide numerous benefits, including one or more of the benefits mentioned herein. Arrangements described herein can allow users to quickly identify which vials contain certain items. For example, in a medicine context, a user can quickly determine which vials contain which type of medicines based upon a color and/or identifier included with the cap cover. Arrangements described herein can be of use to visually impaired users, including elderly patients having more than one medicine. Further, arrangements described herein can be re-useable upon completion of a particular vial. Arrangements described herein can allow easy attachment and removal from vial caps. Further, some arrangements can include a retaining portion that prevents a vial cap and/or cap cover to be lost/misplaced when opening a vial.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible.

What is claimed is:

1. A cover for a vial container, the cover comprising:
at least one side and an end, the at least one side and the end forming a cavity configured to receive a portion of a vial; and
an identifier located on the end of the cover, the identifier including a shape associated with a particular medication.

2. The cover of claim 1, wherein the at least one side and the end form substantially a cylinder with a closed end and an open end.

3. The cover of claim 1, wherein an inner surface of the at least one side matches a contour of a portion of the vial.

4. The cover of claim 1, wherein the cavity is configured to receive a bottom end portion of the vial.

5. The cover of claim 1, wherein the cavity is configured to receive a portion of a vial cap.

6. The cover of claim 1, wherein the shape of the identifier is embossed on an outer surface of the end of the cover.

7. The cover of claim 1, wherein at least a portion of the cover includes a color associated with the identifier and the particular medication.

8. The cover of claim 7, wherein the cover is colored red and the shape of the identifier is a heart, the cover being associated with heart medication.

9. The cover of claim 7, wherein the cover is colored yellow and the shape of the identifier is a sun, the cover being associated with morning medication.

10. The cover of claim 7, wherein the cover is colored purple and the shape of the identifier includes a moon, the cover being associated with evening medication.

11. A vial system for holding medication, the system comprising:
a vial having an open top and a closed bottom end; and
a vial cover configured for operative connection to the vial, the cover comprising:
at least one side and an end, the at least one side and the end forming a cavity configured to receive a portion of the vial; and
an identifier located on the end of the cover, the identifier having a shape associated with a medication held in the vial.

12. The system of claim 11, wherein the at least one side and the end of the cover form substantially a cylinder with a closed end and an open end.

13. The system of claim 11, wherein the cavity is configured to receive the bottom end portion of the vial.

14. The system of claim 11, further comprising a vial cap configured to selectively cover the open top of the vial, and wherein the cavity of the cover being configured to receive a portion of the vial cap.

15. The system of claim 11, wherein the identifier is embossed on an outer surface of the end of the cover.

16. The system of claim 11, wherein at least a portion of the cover includes a color associated with the identifier and the medication associated with the identifier.

17. A cover kit for use with vial containers, the kit comprising:
a first cover comprising:
at least one side and an end, the at least one side and the end forming a cavity configured to receive a portion of a first vial; and
a first identifier located on the end of the cover, the first identifier including a first shape associated with a first medication; and
a second cover comprising:
at least one side and an end, the at least one side and the end forming a cavity configured to receive a portion of a second vial; and
a second identifier located on the end of the cover, the second identifier including a second shape associated with a second medication.

18. The kit of claim 17, further comprising:
a third cover comprising:
at least one side and an end, the at least one side and the end forming a cavity configured to receive a portion of a third vial; and
a second identifier located on the end of the cover, the second identifier including a third shape associated with a third medication.

19. The kit of claim 18, wherein the first medication, the second medication, and the third medication are all different medications, and the first shape, the second shape, and the third shape are all different shapes.

20. The kit of claim 19, wherein the first shape includes a heart shape, the second shape includes a sun shape, and the third shape includes a moon shape.
